(19) United States
(12) Patent Application Publication
(10) Pub. No.: US 2020/0233390 A1
(43) Pub. Date: Jul. 23, 2020

(54) WALL SWITCH WITH ANNUNCIATOR

(71) Applicant: Homeseer Technologies, LLC, Bedford, NH (US)

(72) Inventors: Richard J. Helmke, Bedford, NH (US); Mark D. Colegrove, Bedford, NH (US)

(21) Appl. No.: 16/255,398

(22) Filed: Jan. 23, 2019

(51) Int. Cl. G05B 19/042; G08B 5/36

(52) U.S. Cl. CPC G05B 19/042; G05B 2219/2642; G08B 5/36

(57) ABSTRACT

In one aspect, a wall switch annunciator system with one or more sensors associated with one or more devices for detecting and communicating data regarding the state of the one or more devices with a processor. The processor operably communicates with one or more visual indicators configured or programmable to provide a visual indication of a state or status of the one or more devices based on the data received.

### BACKGROUND

The present invention relates generally to a wall switch system and, more particularly, to a user-programmable wall switch system with annunciator for indicating the status of one or more other devices.

In modern homes and commercial buildings, wall switches are present in virtually every room. Wall switches for turning on and off and controlling the load of lighting fixtures and fans (e.g., ceiling fans) are well known in the art. Wall switches with single color load-tracking light emitting diode (LED) indicators are also known in the art.

The present disclosure provides new and improved wall switch with annunciator feature for providing a visual indication of a state, status, activity, and/or event occurrence of one or more devices or sensors.

It will be recognized that the present development is not limited to use in homes or residential buildings but can be used in any type of building, including commercial buildings, office buildings, garages, warehouses, and so forth.

### SUMMARY

In one aspect, a wall switch annunciator includes a switch operable to control a flow of electric power to a load, one or more visual indicators, and a processor that is operably connected to the one or more visual indicators. The processor is configured to receive a control communication and further to control operation of the one or more visual indicators responsive to the control communication in order to provide a visual indicator of one or both of a status of a device and a state of a sensor.

In another aspect, a wall switch annunciator system includes one or more visual indicators and a switch configured to control a connected load, such as for a dimmable lighting fixture and/or fan (e.g., ceiling fan) having adjustable speed. In certain embodiments, the visual indicators are configured to provide a visual indication of one or more devices or sensors. In certain embodiments, the visual indicators are configured to switch between providing a visual indication of the load status of a connected load and providing a visual indication of a status of one or more devices or sensors. In certain embodiments, the devices or sensors are so-called smart-home devices or sensors.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1A is a front view of a wall switch annunciator with seven LED indicators in accordance with a first exemplary embodiment of the present invention.

FIG. 1B is a front view of a wall switch annunciator with four LED indicators in accordance with a second exemplary embodiment of the present invention.

FIG. 1C is a front view of a wall switch annunciator with one LED indicator in accordance with a third exemplary embodiment of the present invention.

FIG. 2 illustrates a block diagram of the wall switch annunciator embodiment of FIG. 1A.

FIG. 3 illustrates an exemplary network communication system in which the wall switch with annunciator in accordance with this disclosure may be employed.

FIG. 4 illustrates an exemplary flow chart outlining an exemplary method for receiving and displaying device or sensor state/status information.

FIG. 5 illustrates an exemplary flow chart outlining an exemplary dual mode method for receiving and displaying load status information and receiving and displaying device or sensor state/status information.

FIG. 6 is a block diagram of an exemplary information handling system in accordance with this disclosure.

### DETAILED DESCRIPTION OF THE PREFERRED EMBODIMENTS

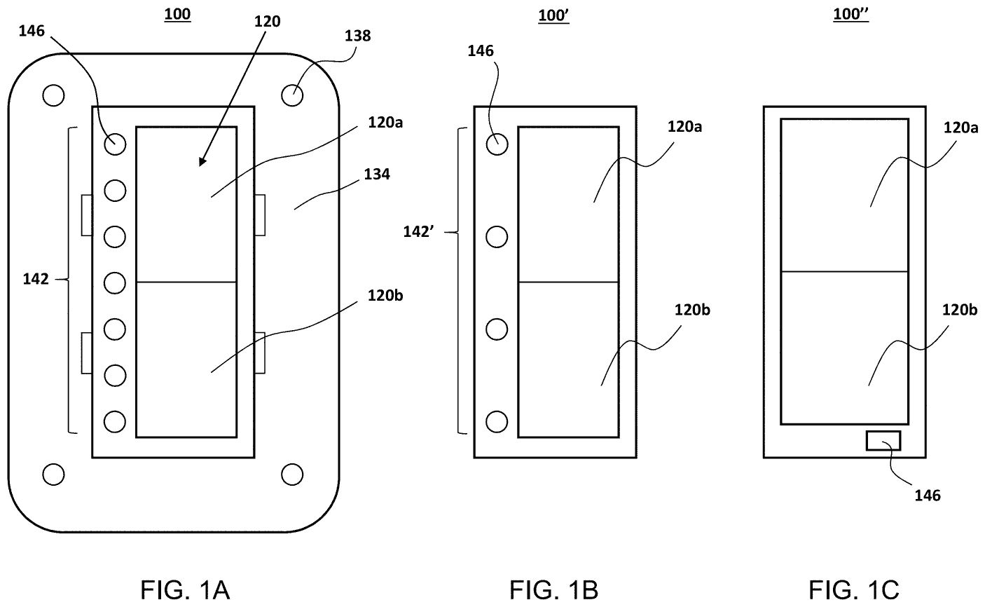

Referring now to the drawings, FIG. 1A illustrates a wall switch with annunciator 100, in accordance with an exemplary embodiment. In certain embodiments, the annunciator includes one or more fastener elements for securing the unit to an electrical box or outlet, such as a mounting plate 134 with openings 138 for receiving threaded fasteners (not shown). A bezel (not shown) may be provided over the mounting plate to provide a desired finished appearance. The wall switch 100 includes a switch actuator for operating a connected load and an indicator array 142 comprising at least one indicator light 146. Although the illustrated annunciator is shown with a paddle switch 120, with a top paddle portion 120a and a bottom paddle portion 120b, for controlling a connected load, it will be recognized that alternative embodiments could employ different types of switches or mechanisms for control, such as rocker switches, knobs, dials, one or more buttons, or slide switches. In certain embodiments, the wall switch annunciator 100 is configured to easily replace a standard electric switch using existing electrical wiring.

FIGS. 1A through 1C illustrate exemplary wall switch annunciators with varying numbers of visual indicators 146. FIG. 1A illustrates a wall switch annunciator 100 having an indicator array 142 having seven indicators 146. FIG. 1B illustrates a wall switch annunciator 100′ having an indicator array 142′ having four indicators 146 but may otherwise be as described herein by way of reference to FIG. 1A. FIG. 1C illustrates a wall switch annunciator 100″ having one indicator 146 but may otherwise be as described herein by way of reference to FIG. 1A. In certain embodiments, the indicators 146 are light emitting diode (LED) indicators; however, it is recognized that other light indicators, such as incandescent lamps or others, may be used. Each LED indicator 146 is preferably a tri-color LED comprising red, green, and blue (RGB) elements in which the intensity of each element can be independently controlled to allow the colors to be mixed to produce virtually any color, including without limitation, red, green, blue, magenta, cyan, yellow, and white. The wall switch 100 may include reflectors and/or diffusers to facilitate the mixing of the red, blue, and green components. Alternatively, each the LED may be a self-contained RGB LED with an integral diffused lens. Alternatively, each LED in the array 142 could also be replaced with one or more dedicated single color LEDs.

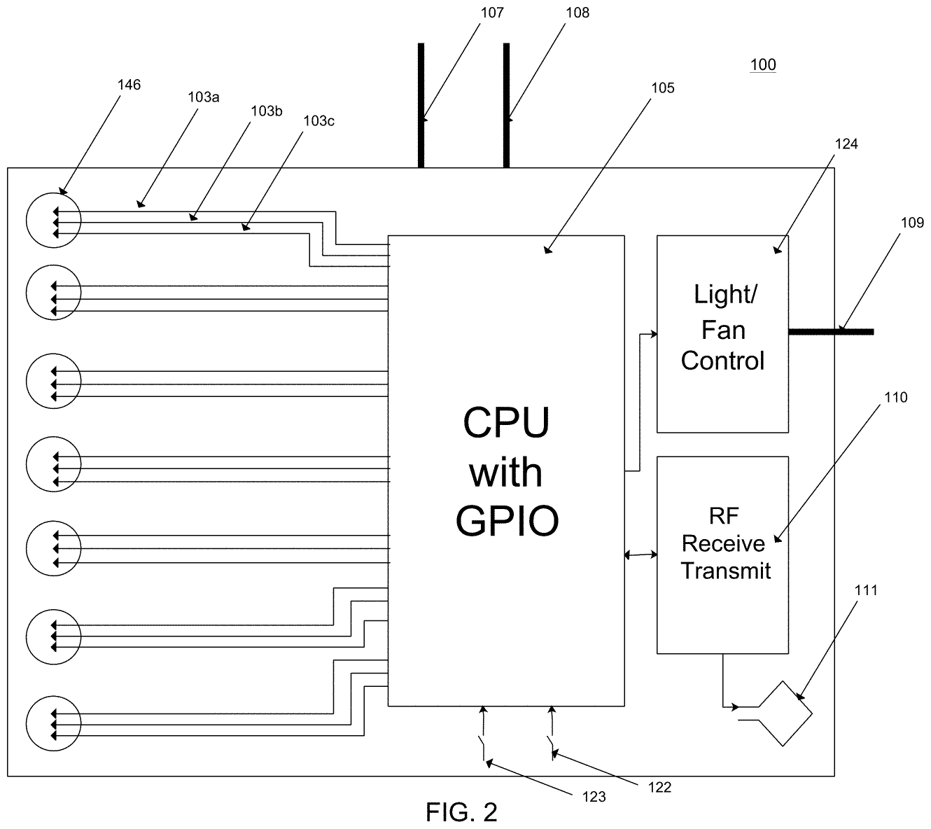

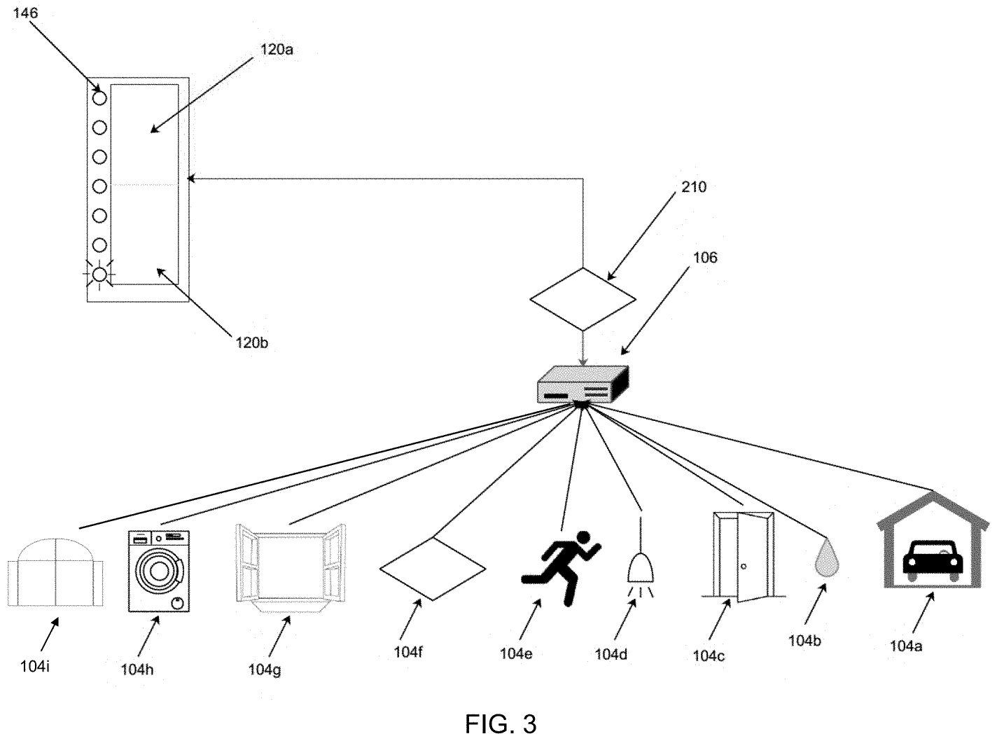

As shown in the illustrated embodiment in FIG. 2, the wall switch annunciator 100 includes a microprocessor or microcontroller 105, which is preferably a central processing unit (CPU) with general purpose input/out (GPIO). In certain embodiments, the CPU is a Z-Wave module, such as a ZM5101 module including a microcontroller and passive RF components for sending and receiving Z-Wave commands for control by the processor 105 or a master device 106 (see FIG. 3), such as a home automation controller. In certain embodiments, the wall switch annunciator 100 is connected to a line terminal that is connected to the house mains line voltage 107 and a ground terminal 108 that is connected to the house mains ground connection. In certain embodiments, the central processing unit 105 includes pulse width modulation (PWM) output for controlling a connected load, such as the dimming functions of a light fixture or adjusting the speed of a fan. The CPU 105 is connected to the one or more visual indicators 146 via control lines 103a-103c. In the illustrated embodiment, there are three control lines 103a-103c for controlling red, blue, and green components, respectively, to achieve a desired color for each LED indicator 146. The voltage setting of each line 103a-103c determines the color emitted by the respective LED indicator 146. Each color in turn is representative of a status of a connected device or sensor.

In certain embodiments, the unit 100 includes load (e.g., light and/or fan) control circuitry 124. In certain on/off switch embodiments, the processor 105 is used to control a relay in the light control circuitry 124 that turns the attached load ON and OFF. In certain dimmer switch embodiments, the PWM outputs on the CPU 105 control the dim level of a light and/or fan speed of a fan attached to the load terminal 109. It will be recognized that the processor 105 may be used to control the load level of other types of connected devices.

In certain embodiments where the switch is a paddle switch with dimmer/fan speed control, the switch has a top paddle portion 120a and a bottom paddle portion 120b. Pressing the top portion 120a activates an upper switch 122 under the paddle 120, which increases the brightness of the connected light fixture. Pressing the bottom portion 120b activates a lower switch 123 under the paddle 120, which decreases the brightness of the connected light switch. Alternatively or additionally, the speed of a ceiling fan is controlled in like manner. In certain alternative embodiments, pressing the top portion 120a activates the upper switch 122 and turns on the attached load, and pressing the bottom portion 120b activates the bottom switch 123 and turns off the attached load.

Referring now to FIG. 3, there appears an exemplary master device 106, such as a smart home system or home automation system, employing the annunciator 100. The master device 106 is configured to receive signals or data from one or more sensors or devices 104, such as sensors and devices 104a-104i, e.g., a garage door sensor 104a, water softener 104b, exterior door sensor 104c, light fixture 104d, home monitoring or personal assistant device 104e, motion detector 104f, exterior window sensor 104g, washing machine or clothes dryer 104h, and gate sensor 104i. It will be recognized that the illustrated sensors and devices are exemplary only and are not intended to be an exhaustive list. Other devices and sensors contemplated include thermostats, humidity or moisture sensors, heat sensors, smoke sensors, hazard sensors, and so forth.

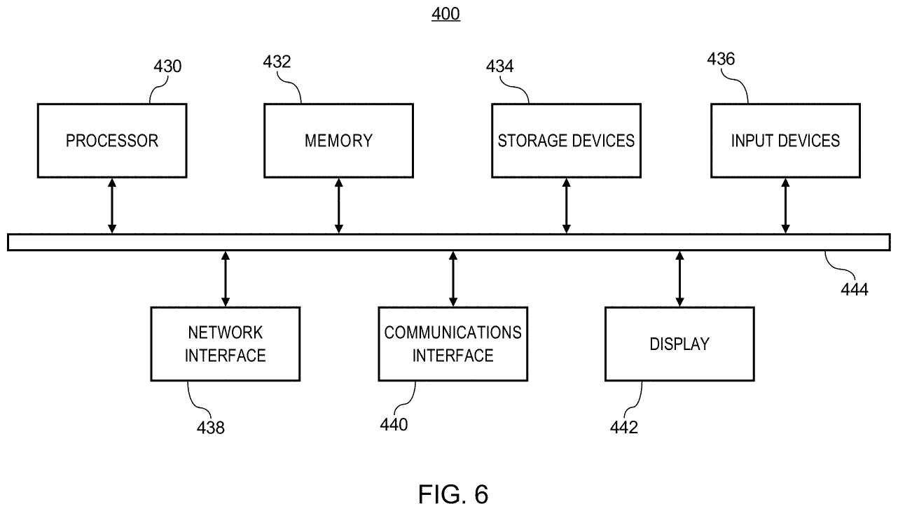

In certain embodiments, the master device 106 may monitor or track device status or events. Data representative of the tracked status or events may be stored in a memory associated with the master device 106 such as memory 432 (see FIG. 6). Exemplary status or events include home or room occupancy, a specific time or event of the day (such as time of sunrise or sunset) or event reminder (such as based on a calendar app). Any of a variety of other home devices are also contemplated, including by way of example, a dehumidifier, dishwasher, security cameras or other devices, and water or chemical detectors, in addition to any of a variety of household states or events capable of being monitored, detected, or tracked by a home automation system or household management devices, such as security zones, temperature. Battery charge levels of devices may also be communicated to the master device 106. A visual indication of any of the foregoing can be provided via a selected one of the visual indicators 146.

In certain embodiments, the home monitoring or personal assistant device 104e may be a feature of the home automation controller 106. In certain embodiments, the microprocessor 105 is programmable to output certain colors to indicate certain sensor or device states, statuses, activities, or event occurrences of a selected device, 104a-104i based on a control communication received. In certain embodiments the master device 106 is programmed via a software application running on computer, mobile device, or other computer-based device in communication with the master device 106, either directly or through a network, which may be a local area network, Wi-Fi networks, the Internet, and so forth.

In certain embodiments, the unit 100 is programmable to function as dual-mode annunciator. For example, in the first mode, or “normal” mode, the indicators 146 in the indicator array 142 will display the relative status of a connected load, such as a the brightness of a dimmable lighting fixture or the speed of a fan with adjustable speeds. In the second mode, or “status” mode, the LED indicators 146 in the array 142 will emit light in a certain color and/or blink based on the status, state, activity, or event occurrence of an associated sensor or device 104a-104i. In certain embodiments, the unit 100 is programmable to remain in “normal” mode until a relevant device status, state, activity, or event occurrence is detected, at which point the unit 100 will switch to “status” mode. In certain embodiments, the unit 100 will revert to “normal” mode after a predefined period of time. In certain alternative embodiments, the unit 100 remains in “status” mode until an adjustment is made to the connected load, such as dimming the light, at which point the unit 100 will switch to “normal” mode. The unit 100 will revert to “status” mode after a predefined period of time.

In certain embodiments, the master device 106 is programmed with program instructions or control logic 210 identifying the occurrence or existence of a particular status, state, activity, and/or event of a sensor or device, such as 104a-104i. For example, whether a device 104a-104i is running or not, when a window or door is open or closed, when a device is at maximum or minimum capacity, when a sensor has been activated, among others. Alternatively or additionally, the master device 106 may be programmed with custom or user-defined device statuses, states, activities, and/or event occurrences. Upon identification by the master device 106 of a certain status, state, activity, and/or event occurrence of the device, the master device 106 will determine what color (if any) or other visual indication (such as blinking) is displayed by the LED indicators 146 and transmit a control communication to the unit 100, which, in turn, drives the LED indicators 146 accordingly. By way of example only, Table 1 shows exemplary correlations between device status, state, activity, or event occurrence and associated visual output for the wall switch annunciator 100 having 7 LEDs in the indicator array 142:

TABLE 1

| | | Device status, state, activity, |
|---|---|---|
| LED Number | Visual Indication | or event occurrence |
| 1 | Steady yellow | Garage door is open |
| 1 | Blinking red | Garage door remains open after |
| | | preset time |
| 2 | Blinking blue | Water softener when refill is needed |
| 2 | Steady green | Water softener is full |
| 3 | Blinking magenta | Motion detected |
| 3 | Off | No motion detected |
| 4 | Steady green | Bathroom is unoccupied |
| 4 | Steady red | Bathroom is occupied |
| 5 | Blinking cyan | Clothes dryer is running |
| 6 | Steady white | Fan is on |
| 6 | Off | Fan is off |
| 7 | Blinking blue | Exterior door is open |

In certain embodiments, the wall switch annunciator 100 includes a radio frequency (RF) transceiver 110 and associated antenna 111, which provides wireless interface between the processor 105 and the master device 106 (see FIG. 3). The RF transceiver 110 sends and receives communication in the form of data packets to and from the master device 106. In certain embodiments, the transceiver 110 communicates directly with an RF transceiver associated with the master device 106. In certain embodiments, the RF transceiver communicates with an RF transceiver associated with a radio communications device or a network to which the master device 106 is attached, such as a Wi-Fi router or the like. Alternatively, the communication between the processor 105 and the master device 106 may be through a hardwired connection. In preferred embodiments, communication between the transceiver 110 and the master device 106 is in accordance with a promulgated standard or protocol, including without limitation Z-Wave, Zigbee, Wi-Fi, Bluetooth, Universal Powerline Bus (UPB), or X10. In certain embodiments, the RF subsystem 110 includes a radio antenna 111 configured for use with the protocol 114.

In certain embodiments, the RF module 110, e.g., a Bluetooth module, is housed within the wall switch annunciator 100 to perform wireless communication with the paired computer based system 106 via a Bluetooth link. As used herein, the term “paired” and variants thereof may refer to a persistent wireless link established between devices. Pairing may involve an authentication step such as the exchange of a passkey between two devices. In certain embodiments, the exchange of a passkey occurs the first time two devices are paired and future connections between the devices are authenticated automatically. The Bluetooth module 110 enables data communication between the wall switch with annunciator 100 and a master device 106.

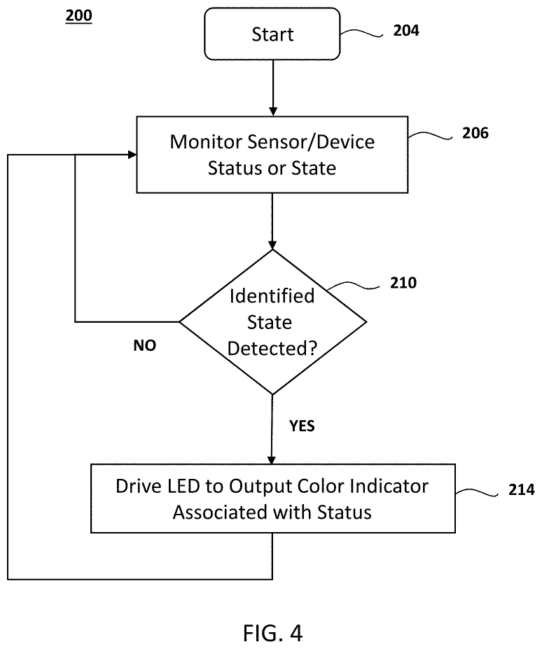

Referring now to FIG. 4, there appears a flow chart outlining an exemplary method 200 in accordance with the present invention. The process starts at step 204, at step 206, device status information and sensor status information from the devices/sensors 104a-104i are monitored, e.g., at periodic time intervals. At step 210, it is determined whether the information received matches with a state or status that activates a visual indicator 146.

If, at step 210, it is determined that the information received does not correspond to a state or status that activates a visual indicator, the process returns to step 206 and repeats. In the event that a relevant state or status is identified, the process continues to step 214 and the master device 106 sends a control communication to the wall switch annunciator 100. The processor 105 in turn drives the appropriate LED indicator 146 to achieve the color or visual indication that corresponds to the state or status received in step 206. The process then returns to step 206 and repeats.

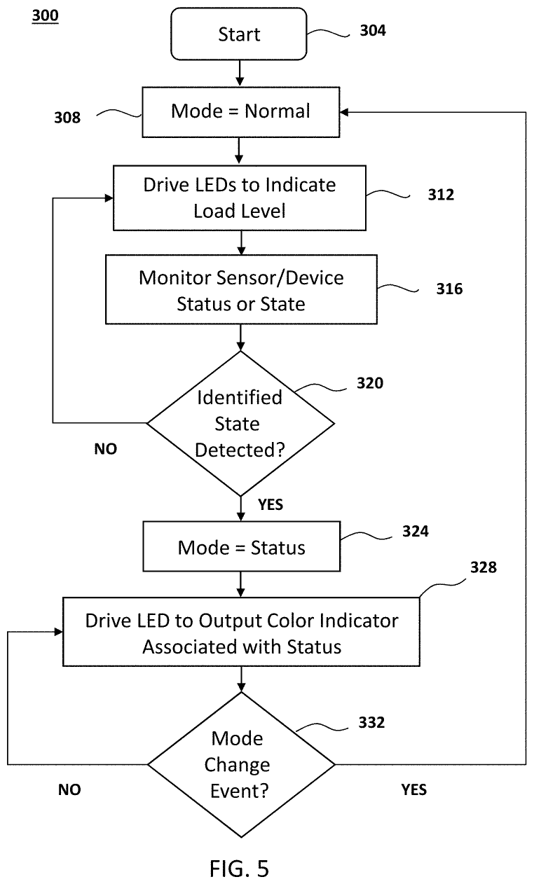

Referring now to FIG. 5, there appears a flow chart outlining an exemplary dual mode method 300 in accordance with the present invention. The process starts at step 304. At step 308, the annunciator mode is set to the initial or default mode, e.g., “normal” mode in the illustrated embodiment. When in normal mode, the processor 105 drives the indicators 146 at step 312 to provide a visual indication of the relative status (e.g., brightness of a dimmable lighting fixture or the speed of a fan with adjustable speeds) of the load connected to the unit 100. At step 312, the microprocessor 105 drives the appropriate LED indicator 146 to achieve the color or other visual indication (such as the number of LEDs in the array that are illustrated) that corresponds to the relative status of the connected load. At step 316, the device status information and sensor status information from devices/sensors 104a-104i are monitored by the computer system 106, e.g., at periodic time intervals.

At step 320, it is determined whether the information received matches with a state or status that activates a visual indicator 146. If, at step 320, it is determined that the information received does not correspond to a state or status that activates a visual indicator, the process returns to step 312 and repeats. In the event that a relevant state or status is identified, the process continues to step 324 wherein a control communication is sent to the processor 105 and the mode is set to “status” mode. In status mode, the process continues to step 328. At step 328, processor 105 drives the appropriate LED indicator 146 responsive to the control communication to achieve the color or visual indication that corresponds to the state or status identified in step 316. At step 332, it is determined whether a mode change event has occurred, e.g., a predetermined period of time expires or an adjustment is made to the connected load. If, at step 332, it is determined that no mode change event has occurred, the process returns to step 328 and repeats. In the event that a mode change event has occurred at step 332, the process then returns to step 308 and repeats.

Referring now to FIG. 6, there appears an exemplary information handling system 400 representative of computer-based information handing system which is operable to embody the presently disclosed system and perform the presently disclosed method. It will be recognized that the system and method herein could be implemented as a module or function within another software application. The hardware system 400 appearing in FIG. 6 is generally representative of a computer-based information handling system, such as a PC, workstation, a mini-computer, mainframe computer, or the like. In certain embodiments, the system 400 is operable to embody the processing system 106.

The hardware system 400 includes a central processing system 430, a memory 432, one or more storage devices 434, including main and auxiliary memory, an input/output (I/O) system 436, a network interface 438, a communications interface 440, and a display system 442 operably connected by a bus 444.

The hardware system 400 is controlled by the central processing system 430, which may include a central processing unit such as a microprocessor or microcontroller for executing programs, performing data manipulations and controlling the tasks of the hardware system. The processor 430 can be any suitable Intel, AMD, Motorola, Texas Instruments, or Sun processor, or the like. Communication with the central processor 430 is implemented through the system bus 444 for transferring information among the components of the hardware system.

The memory 432 provides storage of instructions and data for programs executing on the central processing system 430. The memory 432 is typically semiconductor-based memory as would be generally understood by persons skilled in the art. The storage devices 434 may include semiconductor-based memory such as read-only memory (ROM), programmable read-only memory (PROM), erasable programmable read-only memory (EPROM), electrically erasable programmable read-only memory (EEPROM), flash memory, and so forth. The storage devices 434 may also include a variety of non-semiconductor-based memories, including but not limited to hard disk, floppy disc, compact disc read-only memory (CD-ROM), digital versatile disc read-only memory (DVD-ROM), and so forth.

The display system 442 may comprise a display device and a video display adapter having the components for driving a display device, including video memory, buffer, and graphics engine as desired. The display device may comprise a video monitor such as a cathode ray-tube (CRT) display, liquid-crystal display (LCD), light-emitting diode (LED) display, gas or plasma display, and so forth.

The input/output (I/O) system 436 may comprise one or more controllers or adapters for providing interface functions between one or more I/O devices. The input/output system 436 may comprise one or more serial ports, parallel ports, universal serial bus (USB) ports, IEEE 1394 ports, infrared ports, etc., for interfacing with corresponding I/O devices such as a keyboard, mouse/pointing device, printer, modem, microphone, speaker, and so forth.

The network interface 438 may be connected to a network to communicate with other computers or computer-based systems, external devices, networks, or information sources on the network. The network interface 438 may be a network adapter implementing, for example, IEEE 802 network standards (e.g., IEEE 802.3 for Ethernet networks, IEEE 802.11 for wireless networks, IEEE 802.15 for personal area networks, IEEE 802.16 for broadband wireless metropolitan networks, and so on.).

The communications interface 440 may be connected to a network, such as the Internet for communication with other computers or devices using an ISP and/or a dial up phone system to connect to the network. The communications interface 440 can be a modem, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It should be appreciated that the hardware system 400 of FIG. 6 is illustrative and exemplary only.

The systems and methods disclosed herein can be implemented as sets of instructions resident in the main memory of one or more computer systems. Until required by the computer system, the set of instructions may be stored in another computer readable memory such as a hard disk drive or in a removable memory such as an optical disk for utilization in a DVD-ROM or CD-ROM drive, a magnetic media for utilization in a magnetic media drive, a magneto-optical disk for utilization in a magneto-optical drive, or a memory card for utilization in a memory card slot. Further, the set of instructions can be stored in the memory of another computer and transmitted over a local area network or a wide area network, such as the Internet, when desired by the user. Additionally, the instructions may be transmitted over a network in the form of an applet that is interpreted after transmission to the computer system rather than prior to transmission. One skilled in the art would appreciate that the physical storage of the sets of instructions or applets physically changes the medium upon which it is stored, e.g., electrically, magnetically, chemically, physically, or optically, so that the medium carries computer readable information.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A wall switch annunciator, comprising:
a switch operable to control a flow of electric power to a load;
one or more visual indicators; and
a processor operably connected to the one or more visual indicators, the processor configured to receive a control communication and further configured to control operation of the one or more visual indicators in response to the control communication to provide a visual indication of one or both of a status of a device and a state of a sensor.

2. The wall switch annunciator of claim 1, further comprising a radio frequency receiver configured to receive a radio signal representative of the control communication.

3. The wall switch annunciator of claim 1, wherein the one or more visual indicators includes a plurality of LED light sources.

4. The wall switch annunciator of claim 3, wherein the plurality of LED light sources is selected from the group consisting of 4 LED light sources and 7 LED light sources.

5. The wall switch annunciator of claim 4, wherein each LED light source is a color mixing LED including a plurality of LED elements, wherein at least two of the plurality of LED elements emit light at different wavelengths.

6. The wall switch annunciator of claim 5, wherein each color mixing LED includes three LED elements, wherein the three LED elements are configured to emit, respectively, red light, green light, and blue light.

7. The wall switch annunciator of claim 1, wherein the control communication is received from a master device in communication with one or both of said device and said sensor.

8. The wall switch annunciator of claim 1, wherein the switch is a dimmer switch, and further wherein the processor is configured to control operation of the one or more visual indicators to provide a visual indication of the status of the dimmer switch.

9. The wall switch annunciator of claim 1, wherein the device is selected from the group consisting of: a garage door, a water softener, a washing machine, a clothes dryer, a home monitoring device, a personal assistant device, a security camera, a dishwasher, a dehumidifier, a chemical detector, a water detector, and a motion detector.

10. The wall switch annunciator of claim 1, wherein the device is selected from the group consisting of a door, a garage door, a window, and a gate, and the status information is representative of device status selected from: “open” and “closed.”

11. The wall switch annunciator of claim 1, wherein the status information is an electrically operated appliance and the representative of a device status selected from: “on” and “off.”

12. The wall switch annunciator of claim 1, wherein the device is a battery operated device and the status information is representative of a device status selected from: “low battery,” “fully charged,” and “charging.”

13. The wall switch annunciator of claim 7, wherein the master device is a home automation controller.

14. The wall switch annunciator of claim 1, wherein the control communication is transmitted over a wireless communications protocol selected from the group consisting of Z-Wave, Zigbee, Wi-Fi, Bluetooth, Universal Powerline Bus (UPB), and X10.

15. A wall switch annunciator system comprising:
a switch operable to control the flow of electric power to a load,
one or more visual indicators; and
a processor operably connected to the one or more visual indicators, the processor configured to receive a control communication and further configured to control operation of the one or more visual indicators response to the control communication to provide a visual indication of one or both of a status of a device and a state of a sensor; and
a master device, wherein the master device is configured to receive data representative of a status of one or more devices and generate the control communication responsive to the data.

16. The wall switch annunciator system of claim 15, wherein the master device includes a radio frequency transmitter configured to transmit a radio signal representative of the control communication and the wall switch annunciator includes a radio frequency receiver configured to receive the radio signal representative of the control communication.

17. The wall switch annunciator system of claim 15, wherein the control communication is transmitted over a wireless communications protocol selected from the group consisting of Z-Wave, Zigbee, Wi-Fi, Bluetooth, Universal Powerline Bus (UPB), and X10.
